(19) United States
(12) Patent Application Publication
(10) Pub. No.: US 2017/0108038 A1
(43) Pub. Date: Apr. 20, 2017

(54) A CONTROL DEVICE AND A METHOD FOR CONTROLLING A MAGNETIC LEVITATION SYSTEM

(71) Applicant: LAPPEENRANNAN TEKNILLINEN YLIOPISTO, Lappeenranta (FI)

(72) Inventors: Rafal JASTRZEBSKI, Lappeenranta (FI); Tuomo LINDH, Lappeenranta (FI); Olli PYRHONEN, Lappeenranta (FI); Alexander SMIRNOV, Lappeenranta (FI)

(21) Appl. No.: 15/312,067

(22) PCT Filed: May 29, 2015
(86) PCT No.: PCT/FI2015/050378

§ 371 Date: Nov. 17, 2016

(30) Foreign Application Priority Data
Jun. 6, 2014 (FI) 20145520

(51) Int. Cl. F16C 32/04; H02N 15/00

(52) U.S. Cl. CPC F16C 32/0453; F16C 32/0457; H02N 15/00

(57) ABSTRACT

A control device (101) for controlling a magnetic levitation system includes a controller (103) for controlling one or more voltages directed to one or more windings of the magnetic levitation system on the basis of a deviation of a position of an object (108) to be levitated from a reference position so as to control a resultant magnetic force directed to the object. The controller selects, for each of temporally successive control periods, a control direction so that ability of the resultant magnetic force to decrease the deviation of the position is improved when the resultant magnetic force is changed in the selected control direction. Thereafter, the one or more voltages are selected in accordance with the selected control direction so as to decrease the deviation of the position by changing the resultant magnetic force. Thus, there is no need for nested control loops which are typically challenging to tune.

### FIELD OF THE INVENTION

The invention relates generally to a magnetic levitation system that can be, for example but not necessarily, an active magnetic bearing “AMB”. More particularly, the invention relates to a control device and to a method for controlling a magnetic levitation system. Furthermore, the invention relates to a computer program for controlling a magnetic levitation system.

### BACKGROUND

Magnetic levitation systems, such as e.g. active magnetic bearings “AMB”, are commonly known in the art. Magnetic levitation systems are commonly utilized for supporting a rotating or oscillating object. In many cases, the support at each direction is obtained by balancing attractive forces of two opposite acting magnets and other forces acting on an object to be levitated, where at least one of the magnets is a controllable electromagnet. In principle, it is also possible to balance an attractive force of one controllable electromagnet and other forces, e.g. the gravity force, acting against the attractive force of the electromagnet. The magnetic forces acting in all or some degrees of freedom of the levitated object, e.g. a rotor of an electrical machine, have to be controlled actively because of the inherent instability of the magnetic levitation. The instability is due to the fact that the magnetic attractive force acting between a magnet and an object made of e.g. ferromagnetic material increases when the air-gap between the magnet and the object gets smaller. There are several different kinds of magnetic levitation systems. Some systems use permanent magnets to generate bias magnetic fluxes, others use direct biasing currents to generate the bias fluxes. The biasing is used to overcome static loads, increasing the possible rates of change of magnetic forces and to linearize the magnetic force dependence on control variables.

The magnetic force generated by each electromagnet of a magnetic levitation system can be controlled by controlling the current of the electromagnet under consideration. By controlling the currents of all electromagnets of the magnetic levitation system, a resultant magnetic force can be generated into a desired direction. A control device of the magnetic levitation system constitutes typically an outer control loop and an inner control loop for each degree of freedom of the object to be levitated. The outer control loop receives information expressing the measured or estimated position, and possibly also the velocity, of the object to be levitated and a reference, i.e. desired, position of the object. The outer control loop produces reference values for the currents of the electromagnets acting in the degree of freedom under consideration. The inner control loop receives information expressing the reference values of the currents and the measured or estimated values of the currents. The inner control loop controls the voltages directed to the windings of the electromagnets so that the currents follow the reference values of the currents with a sufficient accuracy. The voltages can be controlled on the basis of the differences between the measured or estimated currents and the reference values of the currents for example with the pulse width modulation “PWM”. Instead of the currents, the control quantities controlled by the inner control loop can be estimated or measured magnetic fluxes generated by the electromagnets or estimated or measured forces directed by the electromagnets to the object to be levitated.

The above-described control principle is, however, not free from challenges. One of the challenges is related to delays created by the outer and inner control loops. The outer control loop has to be tuned to alter the reference values of the currents or other control quantities so slowly that the inner control loop is able to make the currents or other control quantities to follow the changes of the reference values with a sufficient accuracy. If the outer control loop is too fast, i.e. the outer control loop changes the reference values too fast, the differences between the prevailing currents or other control quantities and the reference values may get so big that the position control represented by the outer control loop gets instable. Therefore, as usual in cases having outer and inner control loops, the outer control loop has to be sufficiently slower than the inner control loop. The ability of the inner control loop to generate fast changes in the currents and as well in the forces and in the magnetic fluxes is inherently limited by the inductances of the electromagnets and the upper limits of the available voltages. On the other hand, the outer control loop has to be sufficiently fast in order to provide a sufficiently stiff magnetic suspension. Therefore, it can be quite challenging to construct the outer control loop so that the changes in the reference values of the currents or other control quantities are slow enough for the inner control loop to follow but, on the other hand, the changes are fast enough so as to provide a sufficiently stiff magnetic suspension.

### SUMMARY

The following presents a simplified summary in order to provide a basic understanding of some aspects of various invention embodiments. The summary is not an extensive overview of the invention. It is neither intended to identify key or critical elements of the invention nor to delineate the scope of the invention. The following summary merely presents some concepts of the invention in a simplified form as a prelude to a more detailed description of exemplifying embodiments of the invention.

In accordance with the invention, there is provided a new method for controlling a magnetic levitation system that can be, for example but not necessarily, an active magnetic bearing “AMB”. A method according to the invention comprises:
receiving a position signal indicative of a position of an object levitated by one or more magnetic fluxes, and
controlling one or more voltages directed to one or more windings of the magnetic levitation system on the basis of a deviation of the position of the object from a reference position so as to control the resultant magnetic force directed to the object.

The one or more voltages are controlled by:
selecting, for each of temporally successive control periods, a control direction so that changing the resultant magnetic force in the selected control direction improves ability of a total force acting on the object to decrease the deviation of the position, and
setting, for each of the temporally successive control periods, the one or more voltages in accordance with the selected control direction so as to decrease the deviation of the position by changing the resultant magnetic force with the aid of the one or more voltages.

In the above-described method, the one or more voltages are controlled without a need to form one or more reference values which have to react fast enough to changes in loading conditions in order to provide a sufficiently stiff magnetic suspension, but whose changes have to be slow enough in order to keep the differences between the reference values and the corresponding control quantities, e.g. currents, fluxes, or forces, sufficiently small so as to maintain stability of the magnetic suspension.

The magnetic levitation system can be for example an axial magnetic bearing for supporting an object, e.g. a rotor of an electrical machine, in mutually opposite directions parallel with the axis of rotation of the object. In this case, there are two possible control directions which are mutually opposite to each other. For another example, the magnetic levitation system can be a radial magnetic bearing for supporting an object, e.g. a rotor of an electrical machine, in directions perpendicular to the axis of rotation of the object. In this case, the possible control directions are in a geometric plane perpendicular to the axis of rotation. For a third example, the magnetic levitation system may comprise one or more radial magnetic bearings and one or more axial magnetic bearings. In this case, the magnetic bearings are advantageously controlled separately. For a fourth example, the magnetic levitation system may comprise conical magnetic bearings capable of supporting a rotating object both in the radial directions and in the axial directions.

It is worth noting that also in a case where the magnetic levitation system comprises only one controllable electromagnet for supporting an object against downwards directed loading including the gravity force, there are two possible control directions. One of the control directions is upwards and the other is downwards. If the object is at a position higher than the reference position, the magnetic force directed to the object is changed in the downward control direction, i.e. the upward directed magnetic force is weakened and thus the change of the magnetic force is downwards. This change of the magnetic force improves the ability of the total force acting on the object and including the magnetic force and the gravity force to move the object towards the reference position.

In accordance with the invention, there is provided also a new control device for controlling a magnetic levitation system that can be, for example but not necessarily, an active magnetic bearing “AMB”. A control device according to the invention comprises:
a signal input for receiving a position signal indicative of a position of an object levitated by one or more magnetic fluxes, and
a controller for controlling one or more voltages directed to one or more windings of the magnetic levitation system on the basis of a deviation of the position of the object from a reference position so as to control a resultant magnetic force directed to the object.

The controller is configured to:
select, for each of temporally successive control periods, a control direction so that changing the resultant magnetic force in the selected control direction improves ability of a total force acting on the object to decrease the deviation of the position, and
set, for each of the temporally successive control periods, the one or more voltages in accordance with the selected control direction so as to decrease the deviation of the position by changing the resultant magnetic force with the aid of the one or more voltages.

In accordance with the invention, there is provided also a new magnetic levitation system that comprises:
at least one magnetic actuator comprising one or more windings for generating one or more magnetic fluxes for levitating an object,
equipment for generating a position signal indicative of a position of the object with respect to the magnetic actuator,
one or more controllable voltage sources for directing one or more voltages to the one or more windings, and
a control device according to the invention for controlling the one or more voltages on the basis of a deviation of the position of the object from a reference position so as to control the one or more magnetic fluxes to levitate the object.

In accordance with the invention, there is provided also a new computer program for controlling one or more voltages directed to one or more windings of a magnetic levitation system so as to control a resultant magnetic force directed to an object to be levitated.

A computer program according to the invention comprises computer executable instructions for controlling a programmable processing system of the magnetic levitation system to:
select, for each of temporally successive control periods, a control direction so that changing the resultant magnetic force in the selected control direction improves ability of a total force acting on the object to decrease the deviation of the position, and
set, for each of the temporally successive control periods, the one or more voltages in accordance with the selected control direction so as to decrease the deviation of the position by changing the resultant magnetic force with the aid of the one or more voltages.

In accordance with the invention, there is provided also a new computer program product. The computer program product comprises a non-volatile computer readable medium, e.g. an optical disc, encoded with a computer program according to the invention.

A number of exemplifying and non-limiting embodiments of the invention are described in accompanied dependent claims.

Various exemplifying and non-limiting embodiments of the invention both as to constructions and to methods of operation, together with additional objects and advantages thereof, will be best understood from the following description of specific exemplifying and non-limiting embodiments when read in connection with the accompanying drawings.

The verbs “to comprise” and “to include” are used in this document as open limitations that neither exclude nor require the existence of unrecited features. The features recited in dependent claims are mutually freely combinable unless otherwise explicitly stated. Furthermore, it is to be understood that the use of “a” or “an”, i.e. a singular form, throughout this document does not exclude a plurality.

### BRIEF DESCRIPTION OF THE FIGURES

Exemplifying and non-limiting embodiments of the invention and their advantages are explained in greater detail below in the sense of examples and with reference to the accompanying drawings, in which:

FIG. 1a shows a schematic illustration of a magnetic levitation system comprising a control device according to an exemplifying and non-limiting embodiment of the invention,

FIG. 1b shows a diagram illustrating an exemplifying set of control directions suitable for being used in the control of the magnetic levitation system illustrated in FIG. 1a,

FIG. 1c and 1d show functional block diagrams of control devices according to exemplifying and non-limiting embodiments of the invention for controlling a magnetic levitation system,

FIG. 2 shows a schematic illustration of a magnetic levitation system comprising a control device according to an exemplifying and non-limiting embodiment of the invention,

FIG. 3a shows a flowchart of a method according to an exemplifying and non-limiting embodiment of the invention for controlling a magnetic levitation system, and

FIG. 3b illustrates exemplifying sub-actions for carrying out one of the actions of a method according to an exemplifying and non-limiting embodiment of the invention.

### DESCRIPTION OF EXEMPLIFYING AND NON-LIMITING EMBODIMENTS

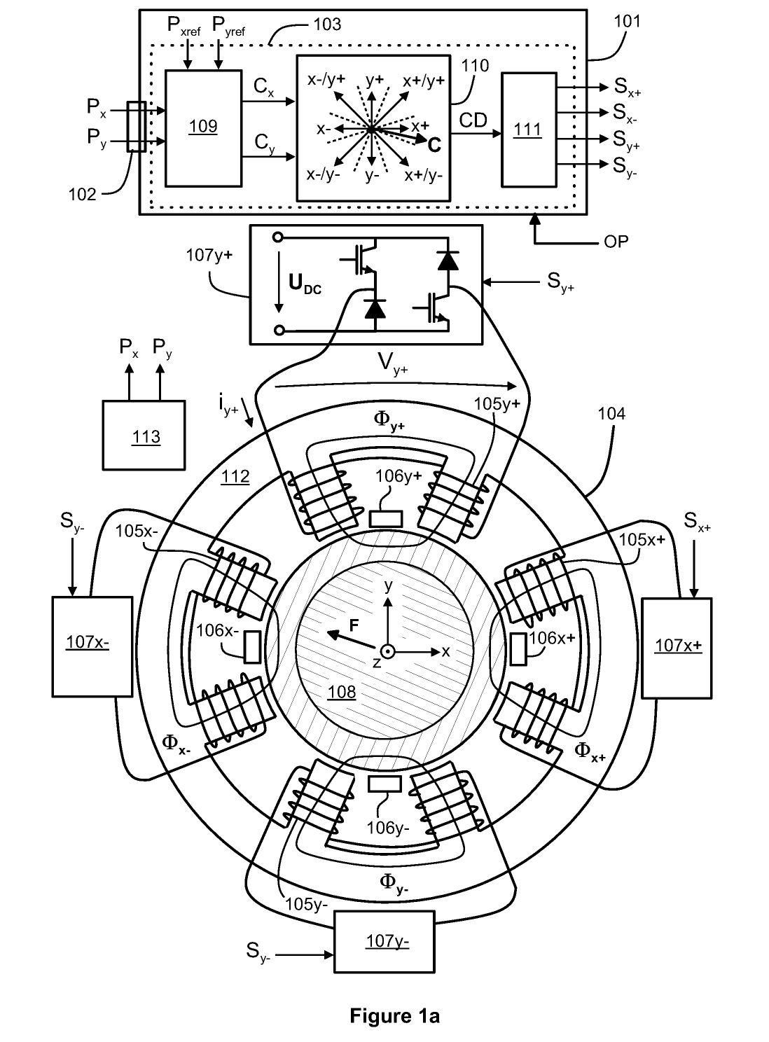

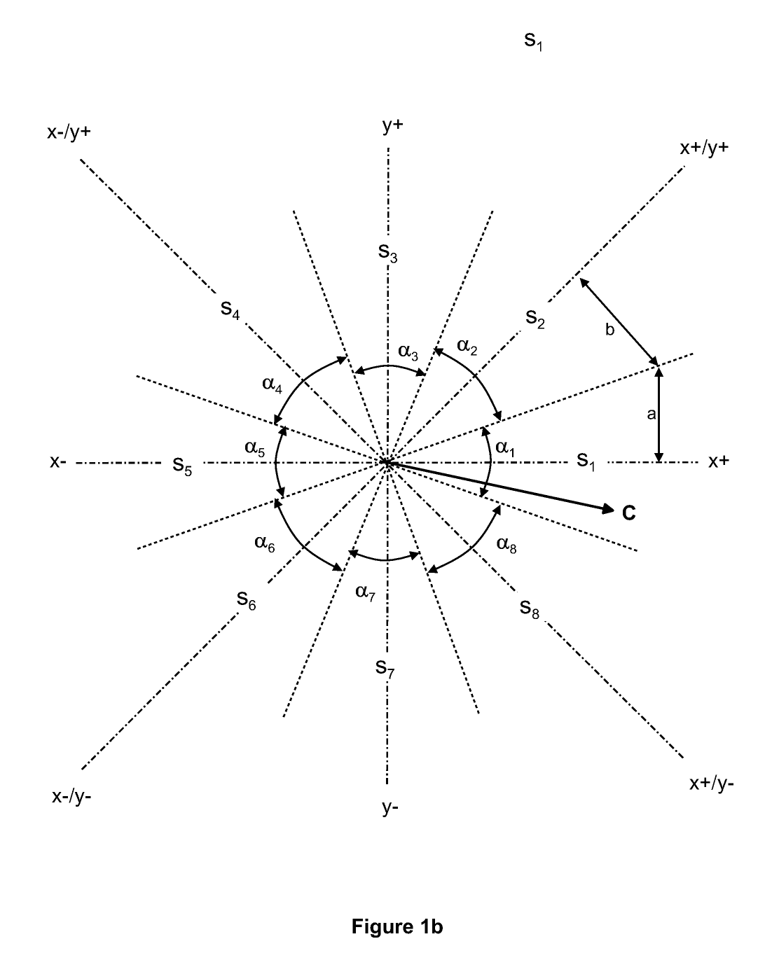

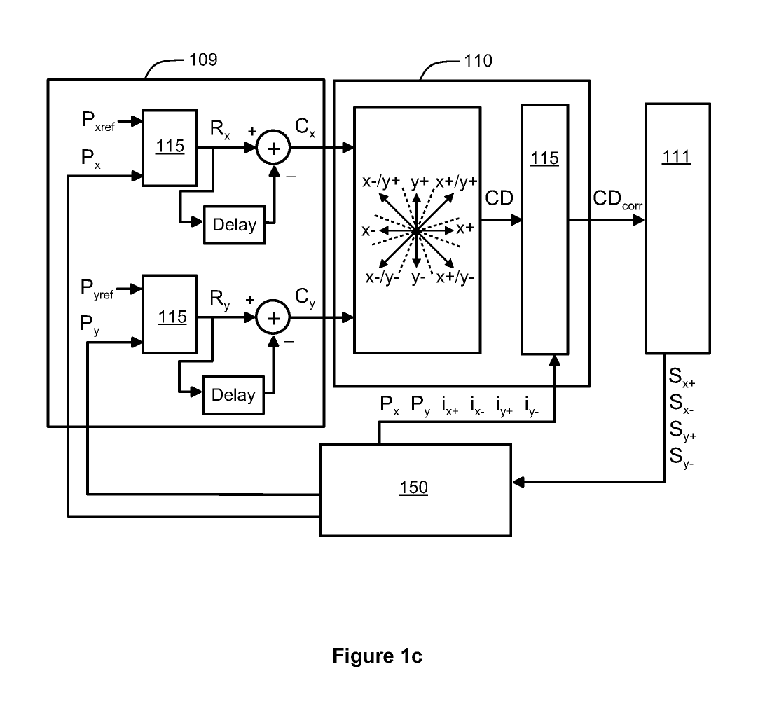

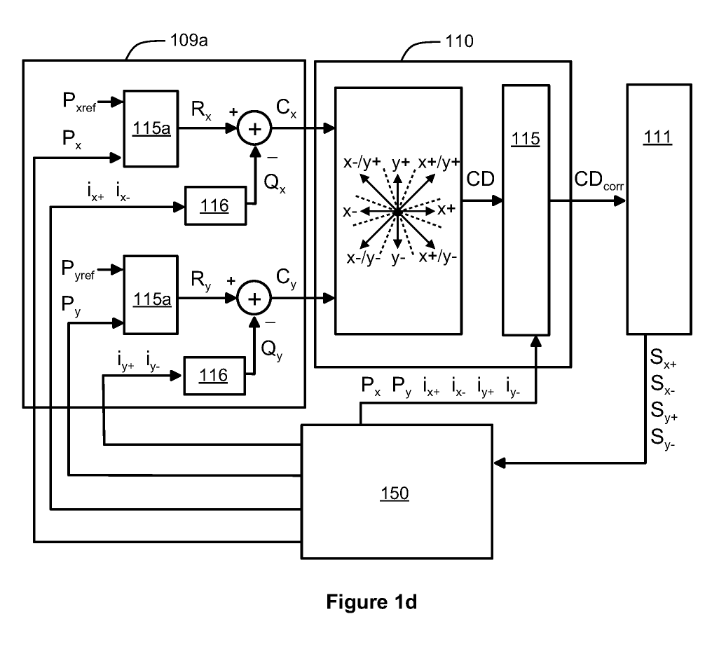

FIG. 1a shows a schematic illustration of a magnetic levitation system comprising a control device 101 according to an exemplifying and non-limiting embodiment of the invention. In the exemplifying case illustrated in FIG. 1a, the magnetic levitation system is a radial magnetic bearing for supporting an object 108 in directions perpendicular to an axis of rotational symmetry of the object. FIG. 1a shows a section view of the object 108. The axis of the rotational symmetry is parallel with the z-axis of the coordinate system shown in FIG. 1a. The object 108 to be levitated can be for example a rotor or an electrical machine. The magnetic levitation system comprises a magnetic actuator 104 constituting electromagnets for magnetically supporting the object 108. The magnetic actuator 104 comprises a ferromagnetic core structure 112 and windings 105x+, 105x−, 105y+ and 105y− for generating magnetic fluxes φₓ₊, φₓ₋, φ_{y+} and φ_{y-} for supporting the object 108 in the xy-plane of the coordinate system. The magnetic levitation system comprises equipment for generating a position signal indicative of a position of the object 108 with respect to the magnetic actuator 104. In this exemplifying case, the position signal comprises components Pₓ and P_{y}, where Pₓ is indicative of the x-coordinate of the rotational symmetry axis of the object 108 and P_{y} is indicative of the y-coordinate of the rotational symmetry axis of the object. Thus, in this exemplifying case, the position signal constitutes a position vector P=Pₓeₓ+P_{y}e_{y} expressing the position of the object 108 in a planar two-dimensional coordinate system, i.e. in the xy-plane, whose origin is at a reference position of the object, i.e. at the desired position of the object. The eₓ and e_{y} are unit vectors defining the positive x- and y-directions of the coordinate system shown in FIG. 1a.

In the exemplifying case illustrated in FIG. 1a, the equipment for generating the position signal comprises sensors 106x+, 106x−, 106y+ and 106y− and a circuitry 113 for generating the components Pₓ and P_{y} of the position signal on the basis of output signals of the sensors. Signal transfer paths from the sensors to the circuitry 113 are not shown in FIG. 1a. The sensors 106x+, 106x−, 106y+ and 106y− can be, for example but not necessarily, inductive sensors where the inductance of each sensor is dependent on the distance from the sensor under consideration to the surface of the object 108, and the circuitry 113 can be configured to form the components Pₓ and P_{y} of the position signal on the basis of differences between the inductances of the sensors. It is also possible that the circuitry 113 is configured to form the components Pₓ and P_{y} of the position signal on the basis of differences between the inductances of the electromagnets supporting the object 108. The inductance of each electromagnet can be indicated by a rate of change of current di/dt when voltage directed to the winding of the electromagnet under consideration is changed in a step-wise manner. In this case, there is no need for the sensors 106x+, 106x−, 106y+ and 106y−.

The magnetic levitation system comprises controllable voltage sources 107x+, 107x−, 107y+ and 107y− for directing controllable voltages to the windings 105x+, 105x−, 105y+ and 105y−. In the exemplifying magnetic levitation system illustrated in FIG. 1a, the voltage sources are three-level voltage sources each of which is capable of producing three discrete voltage values. The main circuit of the voltage source 107y+ is presented in FIG. 1a. Each of the other voltage sources 107x+, 107x− and 107y− has a main circuit similar to that of the voltage source 107y+. As can be seen from the main circuit of the voltage source 107y+, voltage V_{y+} directed to the winding 105y+ is substantially U_{DC} when both transistors of the voltage source 107y+ are conductive, substantially −U_{DC} when both of the transistors are non-conductive and current i_{y+} flows via diodes of the voltage source 107y+, and substantially zero when one of the transistors is conductive and the other is non-conductive and the current flows via the conductive transistor and one of the diodes. Conductive state threshold voltages of the transistors and the diodes and resistances of conductors make the voltage V_{y+} to slightly differ from the above-mentioned values. The voltage sources are controlled by three-level voltage selectors Sₓ₊, Sₓ₋, S_{y+} and S_{y-} so that for example voltage selector S_{y+} determines whether the voltage V_{y+} is positive, negative, or substantially zero.

The magnetic levitation system comprises a control device 101 for controlling the magnetic actuator 104. The control device comprises a signal input 102 for receiving the components Pₓ and P_{y} of the position signal, and a controller 103 for controlling the voltages directed to the windings 105x+, 105x−, 105y+ and 105y− in a time-discrete way at temporally successive control periods. The voltages are controlled on the basis of the deviation between the position of the object 108 and the reference position of the object. In this case, the components Pₓ and P_{y} of the position signal represents the deviation of the position because the origin of the coordinate system shown in FIG. 1a coincides with the reference position. Thus, reference values P_{xref} and P_{yref} of the components Pₓ and P_{y} of the position signal can be assumed to be zeroes. The controller 103 comprises a functional section 109 for producing, for each of the temporally successive control periods, control values Cₓ and C_{y} at least partly on the basis of the components Pₓ and P_{y} of the position signal. The control values Cₓ and C_{y} represent a control vector C=Cₓeₓ+C_{y}e_{y} which indicates a direction in which a resultant magnetic force F directed to the object 108 should be changed in order to decrease the deviation of the position. The resultant magnetic force is the resultant of the magnetic forces directed to the object 108 by the magnetic fluxes φₓ₊, φₓ₋, φ_{y+} and φ_{y-}. Thus, the resultant magnetic force F is (Fₓ₊−Fₓ₋)eₓ+(F_{y+}−F_{y-})e_{y}, where Fₓ₊ is the magnetic force caused by the magnetic flux φₓ₊, Fₓ₋ is the magnetic force caused by the flux φₓ₋, F_{y+} is the magnetic force caused by the magnetic flux φ_{y+}, and F_{y-} is the magnetic force caused by the flux φ_{y-}. The magnetic force caused by, for example, the flux φ_{y+} is directly proportional to the square of the magnetic flux φ_{y+}². Thus, the rate of change dF_{y+}/dt of the magnetic force F_{y+} is directly proportional to 2φ_{y+}×dφ_{y+}/dt which, in turn, is directly proportional to 2φ_{y+}×(V_{y+}−R i_{y+}), where R is the resistance of the winding 105y+ and i_{y+} is the current of the winding 105y+. Thus, the rate of change vector dF/dt of the resultant magnetic force F is proportional to the following vector:

dF/dt˜(2φₓ₊×Vₓ₊−2φₓ₋×Vₓ₋)eₓ+(2φ_{y+}×V_{y+}−2φ_{y-}×V_{y-})e_{y}, (1)

where the effect of the resistances of the windings is neglected, and Vₓ₊, Vₓ₋ and V_{y-} are the voltages directed to the windings 105x+, 105x− and 105y−, respectively. As indicated by Equation (1), the direction of change of the resultant magnetic force F can be controlled with the aid of the voltages directed to the windings 105x+, 105x−, 105y+ and 105y−.

The controller 103 comprises a functional section 110 for selecting, for each of the temporally successive control periods, a control direction CD so that changing the resultant magnetic force F in the selected control direction improves the ability of the resultant magnetic force to decrease the deviation of the position. The controller 103 comprises a functional section 111 for setting, for each of the temporally successive control periods, the voltages Vₓ₊, Vₓ₋, V_{y+} and V_{y-} in accordance with the selected control direction CD so as to decrease the deviation of the position by changing the resultant magnetic force with the aid of the voltages. In this exemplifying case, a value of each of the voltages Vₓ₊, Vₓ₋, V_{y+} and V_{y-} is selected from a finite set of selectable voltage values, i.e. ≈+U_{DC}, ≈0, ≈−U_{DC}, and the selection is accomplished by setting appropriate values to the voltage selectors Sₓ₊, Sₓ₋, S_{y+} and S_{y-}. The functional section 111 can be implemented for example with the aid of a selection look-up table for outputting the voltage selectors Sₓ₊, Sₓ₋, S_{y+} and S_{y-} on the basis of a look-up key comprising an indicator of the selected control direction CD. As the value of each of the voltages V″, Vₓ₋, V_{y}, and V_{y-} is selected from the finite set of selectable voltage values, there are only a finite number of selectable voltage combinations which correspond to different control directions. Therefore, the control direction CD cannot be selected freely but the control direction is selected from a finite set of selectable control directions. In cases where voltages are continuously controllable, the control direction can be selected more freely.

FIG. 1b shows a diagram illustrating an exemplifying set of selectable control directions in the xy-plane of the coordinate system shown in FIG. 1a. In FIG. 1b, the selectable control directions are defined by first geometric lines intersecting each other at the origin and depicted with dot-and-dash lines. For example, the selectable control direction x+ corresponds to a situation where Vₓ₊≈U_{DC} and Vₓ₋≈V_{y+}≈V_{y-}≈0 or where Vₓ₊≈U_{DC} and Vₓ₋≈−U_{DC} and V_{y+}≈V_{y-} ≈0, and the selectable control direction x+/y+ corresponds to a situation where Vₓ₊≈U_{DC}, V_{y+}≈U_{DC} and Vₓ₋ ≈V_{y-} 0 or where Vₓ₊≈U_{DC}, V_{y+}≈U_{DC}, Vₓ₋ ≈−U_{DC}, V_{y-}≈−U_{DC}. It is worth noting that all the possible control directions are not shown in FIG. 1b. For example, a voltage combination Vₓ₊≈U_{DC}, V_{y+}≈U_{DC}, Vₓ₋ ≈−U_{DC}, V_{y-}≈0 corresponds to a control direction that is between the control directions x+ and x+/y+. The xy-plane is divided into sectors s₁, s₂, s₃, s₄, s₅, s₆, s₇, and s₈ by second geometric lines intersecting each other at the origin so that each of the selectable control directions belongs to one of the sectors and a symmetry line of each sector is one of the selectable control directions. In FIG. 1b, the second geometric lines are depicted with dashed lines. The central angles α₁, α₂, α₃, α₄, α₆, α₆, α₇ and α₈ of the sectors are advantageously proportional to magnitudes, i.e. the Euclidean norm, of sector-specific voltage vectors so that a greater magnitude of the sector-specific voltage vector corresponds to a greater central angle of the corresponding sector. Each of the above-mentioned sector-specific voltage vectors is a vector of the voltages corresponding to the control direction related to the sector under consideration. For example, the sector specific voltage vector of the sector s₁ is ≈(U_{DC})eₓ or ≈(2U_{DC})eₓ and the sector specific voltage vector of the sector s₁ is ≈(U_{DC})eₓ+(U_{DC})e_{y} or (2U_{DC})eₓ+(2U_{DC})e_{y}. The central angles α₁-α₈ of the sectors s₁-s₈ can be proportional to the magnitudes of sector-specific voltage vectors for example so that the distances a and b shown in FIG. 1b are directly proportional to the magnitudes of the sector specific voltage vectors. In this case, the ratio sin(αᵢ/2)/Vᵢ is the same for all of the sectors, where αᵢ is the central angle of the i:th sector, Vᵢ is the magnitude of the sector-specific voltage vector related to i:th the sector, and i=1, 2, . . . , 8.

As mentioned earlier, the functional section 111 of the control device 101 can be implemented with the aid of a selection look-up table for outputting the voltage selectors Sₓ₊, Sₓ₋, S_{y+} and S_{y-} on the basis of a look-up key comprising an indicator of the selected control direction. The selection look-up table can be for example according to Table 1 shown below. In Table 1, ‘+’ means that ≈+U_{DC} is directed to the winding under consideration, ‘0’ means that ≈zero voltage is directed to the winding, and ‘−’ means that ≈−U_{DC} is directed to the winding. The row of table 1 is determined on the basis of the control direction and the column is determined according to the winding under consideration. The control directions are denoted in the same way as in FIG. 1b.

TABLE 1
An exemplifying selection look-up table.

| | Winding | | | |
|---|---|---|---|---|
| Control direction | 105x+ | 105y+ | 105x− | 105y− |
| x+ | + | 0 | − | 0 |
| y+ | 0 | + | 0 | − |
| x− | − | 0 | + | 0 |
| y− | 0 | − | 0 | + |
| x+/y+ | + | + | − | − |
| x−/y+ | − | + | + | − |
| x+/y− | + | − | − | + |
| x−/y− | − | − | + | + |

In a control device according to an exemplifying and non-limiting embodiment of the invention, the functional section 109 shown in FIG. 1a is configured to set the direction of the control vector C=Cₓeₓ+C_{y}e_{y} to be opposite to the direction of the position vector P=Pₓeₓ+P_{y}e_{y}, i.e. C=−q P, where q is a positive real number. The functional section 110 of the control device is configured to determine a particular one of the sectors s₁-s₈ to which the control vector C belongs and to select the control direction which belongs to the determined sector. Thereafter, the functional section 111 of the control device selects the appropriate sector-specific voltage vector. In this case, the resultant magnetic force F is attempted to be changed against the direction of the deviation of the position at each of the temporally successive control periods. In the exemplifying situation illustrated in FIG. 1b, the control vector C belongs to the sector s₁ and thus the sector specific voltage vector is ≈(U_{DC})eₓ, i.e. Vₓ₊≈U_{DC} and Vₓ₋ ≈V_{y+}≈V_{y-} ≈0, or the sector specific voltage vector is ≈(2U_{DC})eₓ i.e. Vₓ₊≈U_{DC} and Vₓ₋ ≈−U_{DC} and V_{y+}≈V_{y-} ≈0.

FIG. 1c shows a functional block diagram of the control device 101 shown in FIG. 1a in a case according to an exemplifying and non-limiting embodiment of the invention. In FIG. 1c, the magnetic actuator, the controllable voltage sources, and the equipment for providing the components Pₓ and P_{y} of the position signal are depicted with a block 150. The functional section 109 is configured to produce, for each of the temporally successive control periods, the control values Cₓ and C_{y} at least partly on the basis of the components Pₓ and P_{y} of the position signal. The control values Cₓ and C_{y} represent the control vector C=Cₓeₓ+C_{y}e_{y} which indicates the direction in which the resultant magnetic force F directed to the object 108 should be changed in order to decrease the deviation of the position. The functional section 109 is configured to use a predetermined rule for producing a reference vector R=Rₓeₓ+R_{y}e_{y} on the basis of the position vector P=Pₓeₓ+P_{y-} e_{y}. The reference vector R may represent for example a desired resultant magnetic force F or desired values of some other control quantities defining the operation of the magnetic levitation system, such as e.g. a vector of balances of squares of the currents (iₓ₊²−iₓ₋²)eₓ+(i_{y+}²−i_{y-}²)e_{y}, where iₓ₊, iₓ₋, i_{y+} and i_{y-} are the currents of the windings 105x+, 105x−, 105y+ and 105y−, respectively. The use the predetermined rule for producing the reference vector is depicted with blocks 115 in FIG. 1c. The predetermined rule may comprise for example a proportional and integrative “PI” control algorithm, a proportional, integrative, and derivative “PID” control algorithm, a proportional and derivative “PD” control algorithm, or some other suitable control algorithm. The functional section 109 is configured to subtract, from the reference vector, the previous reference vector corresponding to the previous one of the temporally successive control periods so as to produce the control vector C=Cₓeₓ+C_{y}e_{y}. This approach is based on the assumption that the prevailing values of the control quantities corresponding to the reference vector have reached their reference values by the end of the previous control period, and thus the previous reference vector can be used as an estimate for the control quantities prevailing at the beginning this the control period. The functional section 110 is configured to determine a particular one of the above-mentioned sectors s₁-s₈, FIG. 1b, to which the control vector C belongs and to select the control direction CD which belongs to the determined sector. Thereafter, the functional section 111 of the control device selects the appropriate sector-specific voltage vector.

FIG. 1d shows a functional block diagram of the control device 101 shown in FIG. 1a in a case according to an exemplifying and non-limiting embodiment of the invention. Except for a functional section 109a, the functional block diagram shown in FIG. 1c is similar to the functional block diagram shown in FIG. 1c. The functional section 109a is configured to use a predetermined rule for producing a reference vector R=Rₓeₓ+R_{y}e_{y} on the basis of the position vector P=Pₓeₓ+P_{y}e_{y}.

The reference vector R may represent for example a desired resultant magnetic force F or desired values of some other control quantities defining the operation of the magnetic levitation system, such as e.g. a vector of balances of squares of the currents (iₓ₊²−iₓ₋²)eₓ+(i_{y+}²−i_{y-}²)e_{y}, where iₓ₊, iₓ₋, i_{y+} and i_{y-} are the currents of the windings of the magnetic levitation system. The use of the predetermined rule for producing the reference vector is depicted with blocks 115a in FIG. 1d. Also in this case, the predetermined rule may comprise for example a proportional and integrative “PI” control algorithm, a proportional, integrative, and derivative “PID” control algorithm, a proportional and derivative “PD” control algorithm, or some other suitable control algorithm. The functional section 109a is configured to subtract, from the reference vector R, a vector Q=Qₓeₓ+Q_{y}e_{y} indicative of the prevailing resultant magnetic force F or other control quantities defining the operation of the magnetic levitation system, such as e.g. the vector of balances of squares of the currents (iₓ₊²−iₓ₋²)eₓ+(i_{y+}²−i_{y-}²)e_{y}. In this exemplifying case, the vector Q is derived on the basis of information indicative of the prevailing currents of the windings. Functional blocks 116 shown in FIG. 1d represent the derivation of the vector Q. The information indicative of the prevailing currents comprises measured or estimated values of the currents. In principle, the vector Q could as well be based on measured or estimated magnetic forces or measured or estimated magnetic fluxes.

The above-described control principles are based on the assumption that direction of change of the resultant magnetic force F is sufficiently close to the direction of the following voltage vector:

V=(Vₓ₊−Vₓ₋)eₓ+(V_{y+}−V_{y-})e_{y}, (2)

As presented earlier in Equation (1), the rate of change vector dF/dt of the resultant magnetic force F is proportional to the following vector:

dF/dt˜(2φₓ₊×Vₓ₊−2φₓ₋×Vₓ₋)eₓ+(2φ_{y+}×V_{y+}−2φ_{y-}×V_{y-})e_{y},

As can be seen, the direction of the voltage vector V is the direction of the change of the resultant magnetic force F, i.e. the angle between V and dF/dt is zero, if the magnetic fluxes φₓ₊, φₓ₋, φ_{y+} and φ_{y-} are mutually equal, i.e. φₓ₊=φₓ₋=φ_{y+}=φ_{y-}.

Although this assumption is applicable in many cases, there can be situations where the quality of the control can be improved by using a more accurate model for selecting the voltages directed to the windings of the magnetic levitation system.

In a control device according to an exemplifying and non-limiting embodiment of the invention, the functional section 110 is configured to maintain a correction model for correcting the selection of the control direction. The correction model is depicted with a block 115 in FIGS. 1c and 1d. The correction model contains information about characteristics of magnetic circuits of the magnetic levitation system and is configured to receive input information indicative of the selected control direction CD, the prevailing currents iₓ₊, iₓ₋, i_{y+} and i_{y-} of the windings, and the position vector P=Pₓeₓ+P_{y}e_{y} of the object. The correction model can be implemented for example with the aid of a correction look-up table whose content values can be generated for example by inspecting, e.g. with simulations, how the directions of the vectors V and dF/dt deviate from each other at different values of the currents and at different positions of the object. With the aid of the correction model it is possible take into account factors related to e.g. the geometric shapes of the magnetic circuits, the magnetic saturation, and the effect of the position of the object to be levitated on the generation of the magnetic forces.

A control device according to an exemplifying and non-limiting embodiment of the invention is configured to determine a temporal length of each of the temporally successive control periods on the basis of (i) the control values Cₓ and C_{y} indicating the required changes of the control quantities being controlled, e.g. the x- and y-components of the resultant magnetic force F, and (ii) a fact that the voltages set for the control period under consideration at least partly determine a rate of change of each of the control quantities under consideration. In many cases this approach reduces the switching frequency of the voltage sources because switching is made only when needed. For example the functional entity 111 which selects the voltages can be provided with computing capacity for determining the temporal lengths of the control periods. A simpler and more straightforward approach is to use control periods having a constant temporal length.

A control device according to an exemplifying and non-limiting embodiment of the invention is configured to keep, in order to reduce the switching frequency, the voltages unchanged in response to a situation in which a vector norm of the control vector C=Cₓeₓ+C_{y}e_{y} indicating the required changes of the control quantities is below a pre-determined limit. The vector norm can be for example the Euclidean norm or some other suitable vector norm.

In many magnetic levitation systems, the windings constitute one or more mutually non-overlapping winding groups so that the windings belonging to a same winding group are capable of generating mutually cancelling components of the resultant magnetic force. The meaning of the term “mutually non-overlapping” is that each winding belongs to only one winding group, i.e. none of the winding belongs to two or more winding groups. For example, in the exemplifying magnetic levitation system illustrated in FIG. 1a, the windings 105x+ and 105x− constitute a first winding group and the windings 105y+ and 105y− constitute a second winding group. As the windings belonging to a same winding group are capable of generating mutually cancelling magnetic forces, the resultant magnetic force does not change when the magnetic forces generated by these windings are all changed by a same amount. For example, if the magnetic forces generated by the windings 105x+ and 105x− are both increased or decreased by ΔF, the resultant magnetic force F remains unchanged. The same is valid for the windings 105y+ and 105y− too. Therefore, the currents of the windings 105x+ and 105x− can both be increased or decreased so that the resultant magnetic force F remains unchanged. The same is valid also for the currents of the windings 105y+ and 105y−. Therefore, the same resultant magnetic force F can be achieved at different operating points of the currents of the windings. In other words, in a situation where there is a desired resultant magnetic force F, the operating points of the currents can be on a desired area but, as well, the operating points of the currents can be outside the desired area. In many cases, there is a need to ensure that the operating points of the currents are kept on the desired area because unnecessarily high currents cause significant losses and unnecessarily low currents may lead to a situation where control stops working when one of the currents drops too near to zero. Instead of the currents of the windings, it is possible to consider other operating quantities such as forces or magnetic fluxes which are however tightly related to the currents. Furthermore, it is possible to use the squares of the currents i² as the control quantities under consideration.

Next we consider a winding group of the kind mentioned above, e.g. the winding group constituted by the windings 105x+ and 105x−. The resultant of the magnetic forces generated by the windings of the winding group can be adjusted by using only non-negative changes in the magnetic forces or only non-positive changes in the magnetic forces. This can be understood in the following way. We first assume that a desired change in the resultant of the magnetic forces is accomplished so that some of the magnetic forces are increased, some the magnetic forces are decreased, and possibly some the magnetic forces are kept unchanged. If we want to use only non-positive changes, we decrease all the magnetic forces by an amount that is at least the greatest one of the increases. This does not change the resultant of the magnetic forces but, as a corollary, none of the magnetic forces is increased but each of them is either decreased or kept unchanged. Correspondingly, if we want to use only non-negative changes, we increase all the magnetic forces by an amount that is at least the greatest one of the absolute values of the decreases. This does not change the resultant of the magnetic forces, but as a corollary, none of the magnetic forces is decreased but each of them is either increased or kept unchanged. The operating points of the currents of the windings can be moved upwards by using only non-negative changes in the magnetic forces for adjusting the resultant of the magnetic forces. Correspondingly, the operating points of the currents of the windings can be moved downwards by using only non-positive changes in the magnetic forces for adjusting the resultant of the magnetic forces. This principle is applicable also in e.g. such cases where a magnetic actuator of a radial magnetic bearing comprises six legs and three windings where the windings are positioned 120 degrees apart from each other in the circumferential direction in a corresponding way as the windings 105x+, 105y+, 105x−, and 105y− shown in FIG. 1a are positioned 90 degrees apart from each other the circumferential direction. The above-mentioned three windings constitute a winding group capable of generating three mutually cancelling magnetic forces, i.e. three mutually cancelling components of the resultant magnetic force.

In a control device according to an exemplifying and non-limiting embodiment of the invention, the functional section 111 is configured to use, for each of one or more mutually non-overlapping winding groups each constituted by at least two of the windings and capable of generating mutually cancelling components of the resultant magnetic force, only zero voltages and current-decreasing voltages but not current-increasing voltages in response to a need to decrease operating points of control quantities, e.g. currents, of the winding group under consideration. It is to be noted that the above-mentioned “zero voltage” means typically slightly negative voltage because of the resistances of conductors and the conductive state threshold voltages of power electronic components. In the exemplifying case illustrated in FIG. 1a, the windings 105x+ and 105x− constitute a first one of the above-mentioned winding groups and the windings 105y+ and 105y− constitute a second one of the winding groups.

In a control device according to an exemplifying and non-limiting embodiment of the invention, the functional section 111 is configured to use, for each of the one or more winding groups, only zero voltages and current-increasing voltages but not current-decreasing voltages in response to a need to increase the operating points of the control quantities, e.g. the currents, of the winding group under consideration.

It is worth noting that in cases, such as e.g. the case illustrated in FIG. 1a, where the windings can be grouped into at least two winding groups, it is also possible to handle all the winding as a single winding group. As discussed earlier, the requirement for a winding group is the capability to generate mutually cancelling magnetic forces. When all the windings are handled as a single winding group, the operating points of the control quantities, e.g. currents, of all the windings can be increased by denying the use of current-decreasing voltages and the operating points can be decreased by denying the use of current-increasing voltages but it is naturally not possible to increase the operating points of the control quantities of some of the windings and to simultaneously decrease the operating points of the control quantities of other ones of the windings.

As mentioned earlier, the functional section 111 for selecting the voltages and shown in FIG. 1a, 1c, and 1d can be implemented with the aid of a selection look-up table for outputting the voltage selectors Sₓ₊, Sₓ₋, S_{y+} and S_{y-}. A control device according to an exemplifying and non-limiting embodiment of the invention is configured to maintain the selection look-up table so that the selection look-up table comprises two or more sub-tables each outputting the voltage selectors Sₓ₊, Sₓ₋, S_{y+} and S_{y-} on the basis of the selected control direction CD. The functional section 111 or some other part of the control device 101 is configured to select, for each of one or more mutually non-overlapping winding groups each constituted by at least two of the windings and capable of generating mutually cancelling components of the resultant magnetic force, one of the sub-tables at least partly on the basis of control quantities, e.g. currents, of the winding group under consideration. In the exemplifying case shown in FIG. 1a, the windings 105x+ and 105x− can be deemed to belong to a first winding group that is a winding group-X, and the windings 105y+ and 105y− can be deemed to belong to a second winding group that is a winding group-Y, or all the windings can be deemed to belong to a same winding group.

In conjunction with a control device according to an exemplifying and non-limiting embodiment of the invention, the selection look-up table comprises a first sub-table, a second sub-table, and a third sub-table. The first sub-table is a current-decreasing sub-table which allows only current-decreasing and zero voltages. The second sub-table is a full-voltage sub-table which allows current-decreasing, zero, and current increasing voltages. The third sub-table is a current-increasing sub-table which allows only current-increasing and zero voltages. The above-mentioned sub-tables for the exemplifying magnetic levitation system shown in FIG. 1a are presented below in tables 2a, 2b, and 2c. The second sub-table, Table 2a, is similar to Table 1 shown earlier but it is presented below for the sake of convenience. The notations in the sub-tables are similar to those in Table 1.

TABLE 2a
An exemplifying current-decreasing sub-table.

| | Winding | | | |
|---|---|---|---|---|
| Control direction | 105x+ | 105y+ | 105x− | 105y− |
| x+ | 0 | 0 | − | 0 |
| y+ | 0 | 0 | 0 | − |
| x− | − | 0 | 0 | 0 |
| y− | 0 | − | 0 | 0 |
| x+/y+ | 0 | 0 | − | − |
| x−/y+ | − | 0 | 0 | − |
| x+/y− | 0 | − | − | 0 |
| x−/y− | − | − | 0 | 0 |

TABLE 2b
An exemplifying full-voltage sub-table.

| | Winding | | | |
|---|---|---|---|---|
| Control direction | 105x+ | 105y+ | 105x− | 105y− |
| x+ | + | 0 | − | 0 |
| y+ | 0 | + | 0 | − |
| x− | − | 0 | + | 0 |
| y− | 0 | − | 0 | + |
| x+/y+ | + | + | − | − |
| x−/y+ | − | + | + | − |
| x+/y− | + | − | − | + |
| x−/y− | − | − | + | + |

TABLE 2c
An exemplifying current-increasing sub-table.

| | Winding | | | |
|---|---|---|---|---|
| Control direction | 105x+ | 105y+ | 105x− | 105y− |
| x+ | + | 0 | 0 | 0 |
| y+ | 0 | + | 0 | 0 |
| x− | 0 | 0 | + | 0 |
| y− | 0 | 0 | 0 | + |
| x+/y+ | + | + | 0 | 0 |
| x−/y+ | 0 | + | + | 0 |
| x+/y− | + | 0 | 0 | + |
| x−/y− | 0 | 0 | + | + |

The functional section 111 or some other part of the control device 101 is configured to select the current-decreasing sub-table, Table 2a, for the winding group-X, i.e. the windings 105x+ and 105x−, in response to a need to decrease the operating points of the control quantities, e.g. currents, of the winding group-X. Correspondingly, the functional section 111 or the other part of the control device 101 is configured to select the current-increasing sub-table, Table 2c, for the winding group-X in response to a need to increase the operating points of the control quantities of the winding group-X. Correspondingly, the functional section 111 or some other part of the control device 101 is configured to select the current-decreasing sub-table, Table 2a, for the winding group-Y, i.e. the windings 105y+ and 105y−, in response to a need to decrease the operating points of the control quantities, e.g. currents, of the winding group-y, and to select the current-increasing sub-table, Table 2c, for the winding group-y in response to a need to increase the operating points of the control quantities of the winding group-Y. The need to increase or decrease the operating points is indicated by a control signal OP that is received by the control device 101.

It is worth noting that using the current-decreasing sub-table or the current-increasing sub-table for one winding group and the full-voltage sub-table for another winding group changes the set of the selectable control directions presented in FIG. 1b. For example, in a case where the current-decreasing sub-table or the current-increasing sub-table is used for the winding group-X and the full-voltage sub-table is used for the winding group-Y, the selectable control directions x+/y+, x−/y+, x−/y+, and x+/y− are replaced by control directions whose angle with respect to the x-axis is arctan(2), i.e. not arctan(1)=45 degrees.

In a control device according to an exemplifying and non-limiting embodiment of the invention, the functional section 111 is configured to select, for one of the winding groups, either the current-decreasing or the current-sub-table in response to a situation in which either the current-decreasing or the current-sub-table needs to be selected for another one of the winding groups. In this case, the set of possible control directions remains unchanged with respect to a situation in which the full-voltage sub-tables are used for all winding groups. In a case where the operating points of the control quantities of one of the winding groups are at a desirable area and thus these operating points are not wanted to be changed, the current-decreasing and the current-increasing sub-tables can be used for this winding group alternatively on successive control periods.

In a control device according to another exemplifying and non-limiting embodiment of the invention, the functional section is allowed to select the current-decreasing sub-table or the current-increasing sub-table for one of the winding groups and the full-voltage sub-table for another one of the winding groups. The functional section 110 is configured to change the set of the selectable control directions and the boundaries of the sectors s₁-s₈ shown in FIG. 1b accordingly.

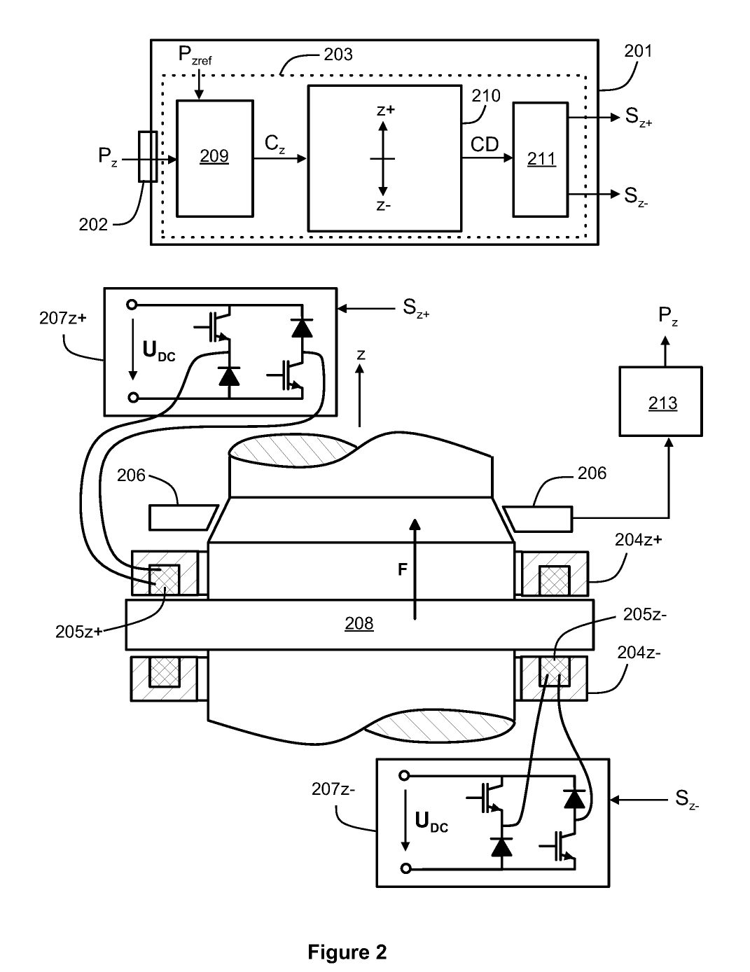

FIG. 2 shows a schematic illustration of a magnetic levitation system comprising a control device 201 according to an exemplifying and non-limiting embodiment of the invention. In the exemplifying case illustrated in FIG. 2, the magnetic levitation system is an axial magnetic bearing for supporting an object 208 in directions parallel to an axis of rotational symmetry of the object. FIG. 2 shows only a part of the object 208. The axis of the rotational symmetry is parallel with the z-axis shown in FIG. 2. The object 208 to be levitated can be for example a rotor or an electrical machine. The magnetic levitation system comprises magnetic actuators 204z+ and 204z− constituting electromagnets for magnetically supporting the object 208. The magnetic actuator 204z+ comprises a ferromagnetic core structure and a windings 205z+ for generating a magnetic flux that directs to the object 208 a magnetic force in the positive direction of the z-axis. Correspondingly, the magnetic actuator 204z− comprises a ferromagnetic core structure and a windings 205z− for generating a magnetic flux that directs to the object 208 a magnetic force in the negative direction of the z-axis. The magnetic levitation system comprises equipment for generating a position signal P_{z} indicative of a position of the object 208 with respect to the magnetic actuators. In this exemplifying case, the position P_{z} is indicative of the z-coordinate of a predetermined point of the object 208.

In the exemplifying case illustrated in FIG. 2, the equipment for generating the position signal comprises sensor 206 and a circuitry 213 for generating the position signal P_{z} on the basis of an output signal of the sensor. The sensor 206 can be, for example but not necessarily, an inductive sensor where the inductance is dependent on the distance from the sensor to a conical surface of the object 208, and the circuitry 213 can be configured to form the position signal P_{z} on the basis of the inductance. The equipment for generating the position signal P_{z} comprises advantageously also another sensor facing towards another conical surface of the object 208, where the other conical surface tapers in the negative z-direction. In this case, the circuitry 213 can be configured to form the position signal P_{z} on the basis of the difference between the inductances of the sensors. The other sensor and the other conical surface of the object 208 are not shown in FIG. 2.

The magnetic levitation system comprises controllable voltage sources 207z+ and 207z− for directing controllable voltages to the windings 205z+ and 205z−. In the exemplifying magnetic levitation system illustrated in FIG. 2, the voltage sources are three-level voltage sources each of which is capable of producing three discrete voltage values. The voltages sources are controlled by three-level voltage selectors S_{z+} and S_{z-} so that for example voltage selector S_{z+} determines whether the voltage produced by the voltage source 207z+ is positive, negative, or substantially zero.

The magnetic levitation system comprises a control device 201 for controlling the magnetic actuators 204z+ and 204z−. The control device comprises a signal input 202 for receiving the position signal P_{z}, and a controller 203 for controlling the voltages directed to the windings 205z+ and 205z− in a time-discrete way at temporally successive control periods. The voltages are controlled on the basis of the deviation between the position of the object 208 and the reference position of the object. The controller 203 comprises a functional section 209 for producing, for each of the temporally successive control periods, a control value C_{z} at least partly on the basis of the position signal P_{z}. The control value C_{z} indicates a direction in which a resultant magnetic force F directed to the object 208 should be changed in order to decrease the deviation of the position.

The controller 203 comprises a functional section 210 for selecting, for each of the temporally successive control periods, a control direction CD so that changing the resultant magnetic force F in the selected control direction improves the ability of the resultant magnetic force to decrease the deviation of the position. The controller 203 comprises a functional section 211 for setting, for each of the temporally successive control periods, the voltages of the windings 205z+ and 205z− in accordance with the selected control direction CD so as to decrease the deviation of the position by changing the resultant magnetic force with the aid of the voltages.

In the exemplifying case illustrated in figure, the windings 205z+ and 205z− constitute a winding group capable of generating mutually cancelling magnetic forces. In a control device according to an exemplifying and non-limiting embodiment of the invention, the functional section 211 is configured to use, for the windings 205z+ and 205z−, only zero voltages and current-decreasing voltages but not current-increasing voltages in response to a need to decrease operating points of control quantities, e.g. currents, of the windings.

In a control device according to an exemplifying and non-limiting embodiment of the invention, the functional section 111 is configured to use, for the windings 205z+ and 205z−, only zero voltages and current-increasing voltages but not current-decreasing voltages in response to a need to increase the operating points of the control quantities, e.g. the currents, of the windings.

The control devices 101 and 201 shown in FIG. 1a and 2 can be implemented with one or more analogue circuits and/or with one or more digital processor circuits, each of which can be a programmable processor circuit provided with appropriate software, a dedicated hardware processor such as, for example, an application specific integrated circuit “ASIC”, or a configurable hardware processor such as, for example, a field programmable gate array “FPGA”.

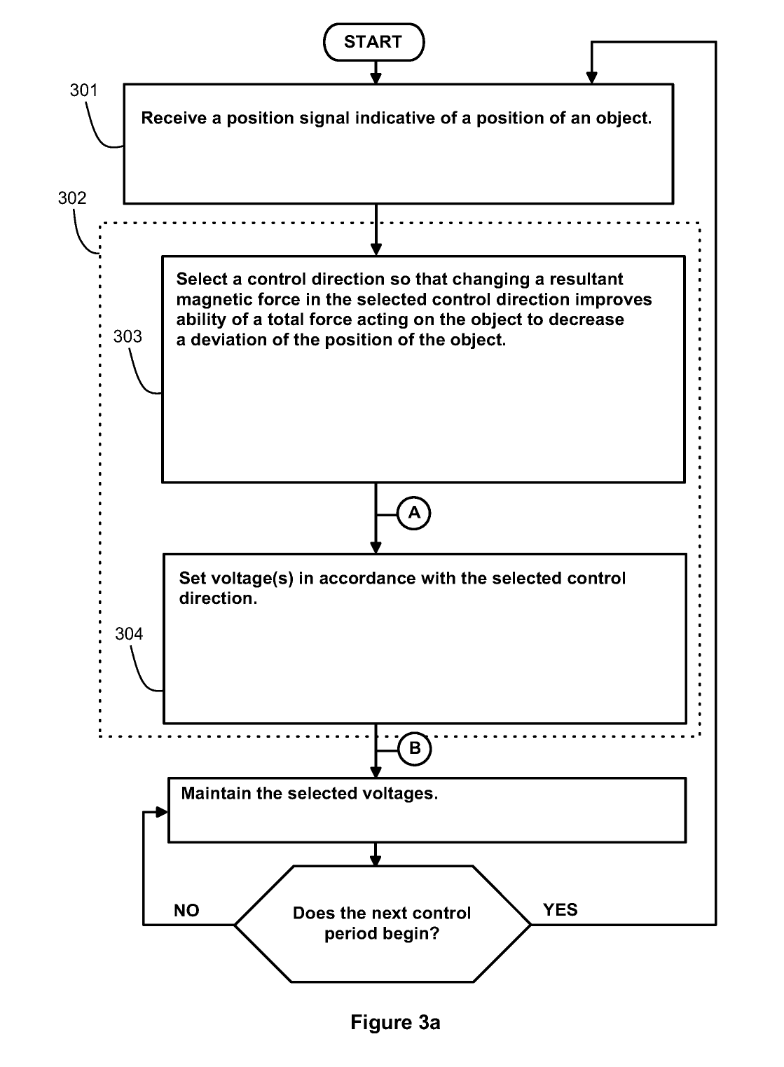

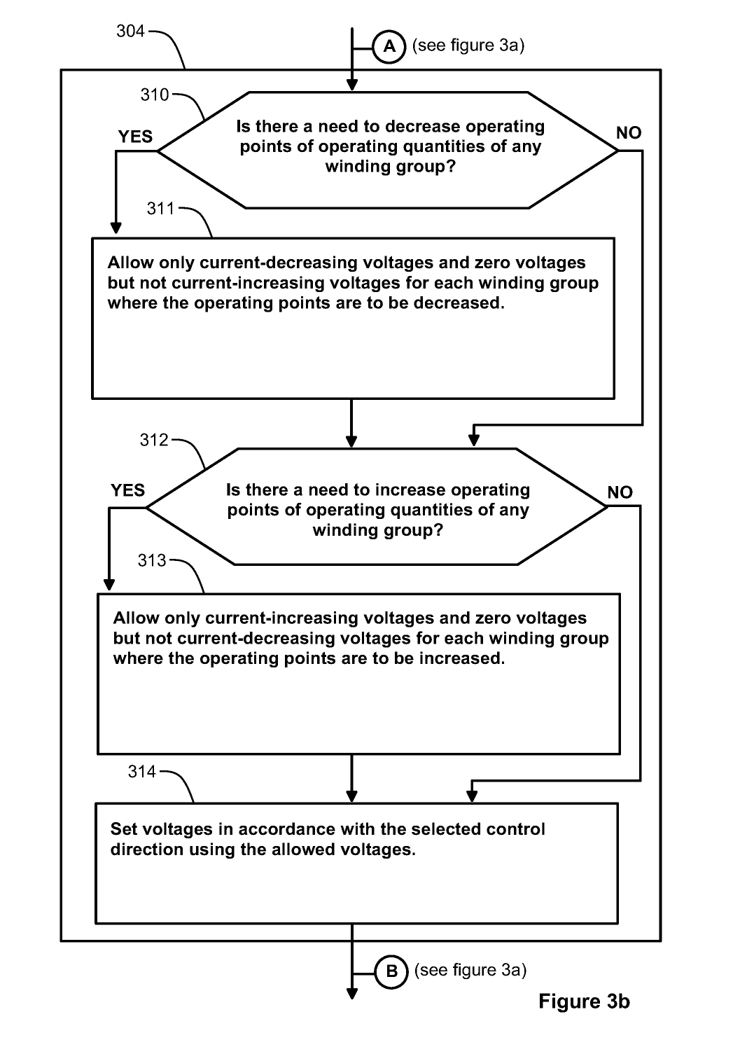

FIG. 3a shows a flowchart of a method according to an exemplifying and non-limiting embodiment of the invention for controlling a magnetic levitation system that can be, for example but not necessarily, an active magnetic bearing “AMB”.

The method comprises:
receiving, in phase 301, a position signal indicative of a position of an object levitated by one or more magnetic fluxes, and
controlling, in phase 302, one or more voltages directed to one or more windings of the magnetic levitation system on the basis of a deviation of the position of the object from a reference position so as to control a resultant magnetic force directed to the object.

The control of the one or more voltages in the phase 302 comprises the following actions:
action 303: selecting, for each of temporally successive control periods, a control direction so that changing the resultant magnetic force in the selected control direction improves ability of a total force acting on the object to decrease the deviation of the position, and
action 304: setting, for each of the temporally successive control periods, the one or more voltages in accordance with the selected control direction so as to decrease the deviation of the position by changing the resultant magnetic force with the aid of the one or more voltages.

In a method according to an exemplifying and non-limiting embodiment of the invention, the action 304 for setting the one or more voltages comprises the following sub-actions illustrated in FIG. 3b:
sub-action 311: allowing, for each of one or more mutually non-overlapping winding groups each constituted by at least two of the windings and capable of generating mutually cancelling components of the resultant magnetic force, only zero voltages and current-decreasing voltages but not current-increasing voltages in response to a need 310 to decrease operating points of operating quantities, e.g. currents, magnetic fluxes, or forces, of the winding group under consideration,
sub-action 313: allowing, for each of the winding groups, only zero voltages and current-increasing voltages but not current-decreasing voltages in response to a need 312 to increase operating points of the operating quantities of the winding group under consideration, and
sub-action 314: setting the one or more voltages in accordance with the selected control direction and using the allowed voltages.

A method according to an exemplifying and non-limiting embodiment of the invention comprises using a predetermined rule for producing, on the basis of the deviation of the position, one or more reference values for one or more control quantities defining operation of the magnetic levitation system. The method comprises subtracting, from the reference values, previous reference values corresponding to a previous one of the temporally successive control periods so as to produce one or more control values. The method comprises selecting the control direction on the basis of the one or more control values.

A method according to an exemplifying and non-limiting embodiment of the invention comprises using a predetermined rule for producing, on the basis of the deviation of the position, one or more reference values for one or more control quantities defining operation of the magnetic levitation system. The method comprises subtracting, from the reference values, prevailing values indicative of the one or more control quantities so as to produce one or more control values. The method comprises selecting the control direction on the basis of the one or more control values.

A method according to an exemplifying and non-limiting embodiment of the invention comprises maintaining a correction model for correcting the selection of the control direction. The correction model contains information about characteristics of magnetic circuits of the magnetic levitation system and is configured to receive input information indicative of the selected control direction, the prevailing currents of the windings, and the position of the object.

A method according to an exemplifying and non-limiting embodiment of the invention comprises determining a temporal length of each of the temporally successive control periods on the basis of (i) the one or more control values indicating required changes of the one or more control quantities and (ii) a fact that the one or more voltages set for the control period under consideration at least partly determine a rate of change of each of the one or more control quantities.

A method according to an exemplifying and non-limiting embodiment of the invention comprises keeping, in order to reduce switching frequency, the one or more voltages unchanged with respect to corresponding one or more voltages used during a previous one of the temporally successive control periods in response to a situation in which a vector norm of the one or more control values is below a pre-determined limit.

A method according to an exemplifying and non-limiting embodiment of the invention comprises selecting the control direction from among a set of selectable control directions, e.g. x+, x−, y+, y−, x+/y+, x+/y−, x−/y+, x−/y− shown in FIG. 1b, and selecting, for each of the one or more voltages, a voltage value from among a set of selectable voltage values, e.g. ≈+U_{DC}, ≈0, ≈−U_{DC}, in accordance with the selected control direction.

A method according to an exemplifying and non-limiting embodiment of the invention comprises maintaining a selection look-up table for outputting one or more voltage selectors on the basis of a look-up key comprising an indicator of the selected control direction, the one or more voltage selectors being suitable for controlling one or more controllable voltage sources to produce the one or more voltages in accordance with the selected control direction.

In a method according to an exemplifying and non-limiting embodiment of the invention, the selection look-up table comprises two or more sub-tables each outputting the one or more voltage selectors on the basis of the selected control direction. The method comprises selecting, for each of one or more mutually non-overlapping winding groups each constituted by at least two of the windings and capable of generating mutually cancelling components of the resultant magnetic force, one of the sub-tables at least partly on the basis of operating quantities of the winding group under consideration.

In a method according to an exemplifying and non-limiting embodiment of the invention, a first one of the sub-tables allows only current-decreasing and zero voltages, a second one of the sub-tables allows current-decreasing, zero, and current increasing voltages, and a third one of the sub-tables allows only current-increasing and zero voltages. The method comprises selecting the first one of the sub-tables in response to a need to decrease operating points of the operating quantities of the winding group under consideration, and selecting the third one of the sub-tables in response to a need to increase the operating points of the operating quantities of the winding group under consideration.

A method according to an exemplifying and non-limiting embodiment of the invention comprises selecting, for a first one of the winding groups, either the first or third one of the sub-tables in response to a situation in which either the first or third one of the sub-tables needs to be selected for a second one of the winding groups.

In a method according to an exemplifying and non-limiting embodiment of the invention, the position signal constitutes a position vector expressing the position of the object in a planar two-dimensional coordinate system whose origin is at the reference position and where the selectable control directions are defined by first geometric lines intersecting each other at the origin of the planar two-dimensional coordinate system. The method comprises selecting one of the selectable control directions so that changing the resultant magnetic force in the selected control direction improves the ability of the total force to decrease the magnitude of the position vector.

In a method according to an exemplifying and non-limiting embodiment of the invention, the planar two-dimensional coordinate system is divided into sectors by second geometric lines intersecting each other at the origin so that each of the selectable control directions belongs to one of the sectors and a symmetry line of each sector is one of the selectable control directions.

A method according to an exemplifying and non-limiting embodiment of the invention comprises determining a particular one of the sectors to which an opposite vector of the position vector belongs and selecting the control direction which belongs to the determined sector.

A method according to an exemplifying and non-limiting embodiment of the invention comprises using a predetermined rule for producing, on the basis of the position vector, a reference vector of control quantities defining operation of the magnetic levitation system. The method comprises subtracting, from the reference vector, previous reference vector corresponding to a previous one of the temporally successive control periods so as to produce a control vector. Furthermore, the method comprises determining a particular one of the sectors to which the control vector belongs and selecting the control direction which belongs to the determined sector.

A method according to an exemplifying and non-limiting embodiment of the invention comprises using a predetermined rule for producing, on the basis of the position vector, a reference vector of control quantities defining operation of the magnetic levitation system. The method comprises subtracting, from the reference vector, a vector indicative of prevailing values of the control quantities so as to produce a control vector. Furthermore, the method comprises determining a particular one of the sectors to which the control vector belongs and selecting the control direction which belongs to the determined sector.

In a method according to an exemplifying and non-limiting embodiment of the invention, the central angles of the sectors are proportional to magnitudes of sector-specific voltage vectors so that a greater magnitude of the sector-specific voltage vector corresponds to a greater central angle of the corresponding sector. Each sector-specific voltage vector is a vector of the voltages corresponding to the control direction related to the sector under consideration.

In a method according to an exemplifying and non-limiting embodiment of the invention, the ratio sin(αᵢ/2)/Vᵢ is a same for all of the sectors, where αᵢ is the central angle of the i:th sector, Vᵢ is the magnitude of the sector-specific voltage vector related to i:th the sector, and i=1, 2, . . . , N, the N being a number of the sectors.

A method according to an exemplifying and non-limiting embodiment of the invention comprises maintaining a correction look-up table for correcting the selection of the control direction. The correction look-up table contains information about characteristics of magnetic circuits of the magnetic levitation system and is configured to receive input information indicative of the selected control direction, the prevailing currents of the windings, and the position of the object.

A computer program according to an exemplifying and non-limiting embodiment of the invention comprises computer executable instructions for controlling a programmable processing system to carry out actions related to a method according to any of the above-described exemplifying embodiments of the invention.

A computer program according to an exemplifying and non-limiting embodiment of the invention comprises software means for controlling a programmable processing system to control one or more voltages directed to one or more windings of a magnetic levitation system on the basis of a deviation of a position of an object from a reference position of the object so as to control a resultant magnetic force directed to the object. The software means comprise computer executable instructions for controlling the programmable processing system to:
select, for each of temporally successive control periods, a control direction so that changing the resultant magnetic force in the selected control direction improves ability of a total force acting on the object to decrease the deviation of the position, and
set, for each of the temporally successive control periods, the one or more voltages in accordance with the selected control direction so as to decrease the deviation of the position by changing the resultant magnetic force with the aid of the one or more voltages.

In a computer program according to an exemplifying and non-limiting embodiment of the invention, the software means further comprise computer executable instructions for controlling the programmable processing system to use, for each of one or more mutually non-overlapping winding groups each constituted by at least two of the windings and capable of generating mutually cancelling components of the resultant magnetic force, only zero voltages and current-decreasing voltages in response to a need to decrease operating points of operating quantities of the winding group under consideration.

In a computer program according to an exemplifying and non-limiting embodiment of the invention, the software means further comprise computer executable instructions for controlling the programmable processing system to use, for each of one or more mutually non-overlapping winding groups each constituted by at least two of the windings and capable of generating mutually cancelling components of the resultant magnetic force, only zero voltages and current-increasing voltages in response to a need to increase operating points of operating quantities of the winding group under consideration.

The software means can be e.g. subroutines or functions implemented with a suitable programming language and with a compiler suitable for the programming language and for the above-mentioned programmable processing system.

A computer program product according to an exemplifying and non-limiting embodiment of the invention comprises a computer readable medium, e.g. an optical disc, encoded with a computer program according to an exemplifying embodiment of invention.

A signal according to an exemplifying and non-limiting embodiment of the invention is encoded to carry information defining a computer program according to an exemplifying embodiment of invention.

The specific examples provided in the description given above should not be construed as limiting the scope and/or the applicability of the appended claims.

1-28. (canceled)

29. A control device for controlling a magnetic levitation system, the control device comprising:
a signal input for receiving a position signal indicative of a position of an object levitated by one or more magnetic fluxes, and
a controller for controlling one or more voltages directed to one or more windings of the magnetic levitation system on the basis of a deviation of the position of the object from a reference position so as to control a resultant magnetic force directed to the object,
wherein the controller is configured to:
select, for each of temporally successive control periods, a control direction so that changing the resultant magnetic force in the selected control direction improves ability of a total force acting on the object to decrease the deviation of the position, and
set, for each of the temporally successive control periods, the one or more voltages in accordance with the selected control direction so as to decrease the deviation of the position by changing the resultant magnetic force with the one or more voltages.

30. The control device according to claim 29, wherein the controller is configured to use, for each of one or more mutually non-overlapping winding groups each constituted by at least two of the windings and capable of generating mutually cancelling components of the resultant magnetic force, only zero voltages and current-decreasing voltages in response to a need to decrease operating points of operating quantities of the winding group under consideration.

31. The control device according to claim 29, wherein the controller is configured to use, for each of one or more mutually non-overlapping winding groups each constituted by at least two of the windings and capable of generating mutually cancelling components of the resultant magnetic force, only zero voltages and current-increasing voltages in response to a need to increase operating points of operating quantities of the winding group under consideration.

32. The control device according to claim 29, wherein the controller is configured to use a predetermined rule for producing, on the basis of the deviation of the position, one or more reference values for one or more control quantities defining operation of the magnetic levitation system and to subtract, from the reference values, previous reference values corresponding to a previous one of the temporally successive control periods so as to produce one or more control values, and to select the control direction on the basis of the one or more control values.

33. The control device according to claim 29, wherein the controller is configured to use a predetermined rule for producing, on the basis of the deviation of the position, one or more reference values for one or more control quantities defining operation of the magnetic levitation system and to subtract, from the reference values, prevailing values indicative of the one or more control quantities so as to produce one or more control values, and to select the control direction on the basis of the one or more control values.

34. The control device according to claim 29, wherein the controller is configured to maintain a correction model for correcting the selection of the control direction, the correction model containing information about characteristics of magnetic circuits of the magnetic levitation system and configured to receive input information indicative of the selected control direction, the prevailing currents of the windings, and the position of the object.

35. The control device according to claim 32, wherein the controller is configured to determine a temporal length of each of the temporally successive control periods on the basis of (i) the one or more control values indicating required changes of the one or more control quantities and (ii) a fact that the one or more voltages set for the control period under consideration at least partly determine a rate of change of each of the one or more control quantities.

36. The control device according to claim 32, wherein the controller is configured to keep, in order to reduce switching frequency, the one or more voltages unchanged with respect to corresponding one or more voltages used during a previous one of the temporally successive control periods in response to a situation in which a vector norm of the one or more control values is below a pre-determined limit.

37. The control device according to claim 29, wherein the controller is configured to select the control direction from among a set of selectable control directions and to select, for each of the one or more voltages, a voltage value from among a set of selectable voltage values in accordance with the selected control direction.

38. The control device according to claim 37, wherein the controller is configured to maintain a selection look-up table for outputting one or more voltage selectors on the basis of a look-up key comprising an indicator of the selected control direction, the one or more voltage selectors being suitable for controlling one or more controllable voltage sources to produce the one or more voltages in accordance with the selected control direction.

39. The control device according to claim 38, wherein the selection look-up table comprises two or more sub-tables each outputting the one or more voltage selectors on the basis of the selected control direction, and the controller is configured to select, for each of one or more mutually non-overlapping winding groups each constituted by at least two of the windings and capable of generating mutually cancelling components of the resultant magnetic force, one of the sub-tables at least partly on the basis of operating quantities of the winding group under consideration.

40. The control device according to claim 39, wherein a first one of the sub-tables allows only current-decreasing and zero voltages, a second one of the sub-tables allows current-decreasing, zero, and current increasing voltages, and a third one of the sub-tables allows only current-increasing and zero voltages, and the controller is configured to select the first one of the sub-tables in response to a need to decrease operating points of the operating quantities of the winding group under consideration, and to select the third one of the sub-tables in response to a need to increase the operating points of the operating quantities of the winding group under consideration.

41. The control device according to claim 40, wherein the controller is configured to select, for a first one of the winding groups, either the first or third one of the sub-tables in response to a situation in which either the first or third one of the sub-tables needs to be selected for a second one of the winding groups.

42. The control device according to claim 37, wherein the position signal constitutes a position vector expressing the position of the object in a planar two-dimensional coordinate system whose origin is at the reference position and the selectable control directions are defined by first geometric lines intersecting each other at the origin of the planar two-dimensional coordinate system, and the controller is configured to select one of the selectable control directions so that changing the resultant magnetic force in the selected control direction improves the ability of the total force to decrease the magnitude of the position vector.

43. The control device according to claim 42, wherein the planar two-dimensional coordinate system is divided into sectors by second geometric lines intersecting each other at the origin so that each of the selectable control directions belongs to one of the sectors and a symmetry line of each sector is one of the selectable control directions, and the controller is configured to determine a particular one of the sectors to which an opposite vector of the position vector belongs and to select the control direction which belongs to the determined sector.

44. The control device according to claim 42, wherein the planar two-dimensional coordinate system is divided into sectors by second geometric lines intersecting each other at the origin so that each of the selectable control directions belongs to one of the sectors and a symmetry line of each sector is one of the selectable control directions, and the controller is configured to use a predetermined rule for producing, on the basis of the position vector, a reference vector of control quantities defining operation of the magnetic levitation system and to subtract, from the reference vector, previous reference vector corresponding to a previous one of the temporally successive control periods so as to produce a control vector, and the controller is configured to determine a particular one of the sectors to which the control vector belongs and to select the control direction which belongs to the determined sector.

45. The control device according to claim 42, wherein the planar two-dimensional coordinate system is divided into sectors by second geometric lines intersecting each other at the origin so that each of the selectable control directions belongs to one of the sectors and a symmetry line of each sector is one of the selectable control directions, and the controller is configured to use a predetermined rule for producing, on the basis of the position vector, a reference vector of control quantities defining operation of the magnetic levitation system and to subtract, from the reference vector, a vector indicative of prevailing values of the control quantities so as to produce a control vector, and the controller is configured to determine a particular one of the sectors to which the control vector belongs and to select the control direction which belongs to the determined sector.

46. The control device according to claim 43, wherein central angles of the sectors are proportional to magnitudes of sector-specific voltage vectors so that a greater magnitude of the sector-specific voltage vector corresponds to a greater central angle of the corresponding sector, each sector-specific voltage vector being a vector of the voltages corresponding to the control direction related to the sector under consideration.

47. The control device according to claim 46, wherein a ratio sin(αᵢ/2)/Vᵢ is a same for all of the sectors, where αᵢ is the central angle of the i:th sector, Vᵢ is the magnitude of the sector-specific voltage vector related to i:th the sector, and i=1, 2, . . . , N, the N being a number of the sectors.

48. The control device according to claim 37, wherein the controller is configured to maintain a correction look-up table for correcting the selection of the control direction, the correction look-up table containing information about characteristics of magnetic circuits of the magnetic levitation system and configured to receive input information indicative of the selected control direction, the prevailing currents of the windings, and the position of the object.

49. A magnetic levitation system comprising:
at least one magnetic actuator comprising one or more windings for generating one or more magnetic fluxes for levitating an object,
equipment for generating a position signal indicative of a position of the object with respect to the magnetic actuator,
one or more controllable voltage sources for directing one or more voltages to the one or more windings, and
a control device for controlling the one or more voltages on the basis of a deviation of the position of the object from a reference position so as to control a resultant magnetic force directed to the object by the one or more magnetic fluxes,
wherein the control device comprises a signal input configured to receive the position signal and a controller configured to:
select, for each of temporally successive control periods, a control direction so that changing the resultant magnetic force in the selected control direction improves ability of a total force acting on the object to decrease the deviation of the position, and
set, for each of the temporally successive control periods, the one or more voltages in accordance with the selected control direction so as to decrease the deviation of the position by changing the resultant magnetic force with the one or more voltages.

50. A method for controlling a magnetic levitation system, the method comprising:
receiving a position signal indicative of a position of an object levitated by one or more magnetic fluxes, and
controlling one or more voltages directed to one or more windings of the magnetic levitation system on the basis of a deviation of the position of the object from a reference position so as to control a resultant magnetic force directed to the object,
wherein the one or more voltages are controlled by:
selecting, for each of temporally successive control periods, a control direction so that changing the resultant magnetic force in the selected control direction improves ability of a total force acting on the object to decrease the deviation of the position, and
setting, for each of the temporally successive control periods, the one or more voltages in accordance with the selected control direction so as to decrease the deviation of the position by changing the resultant magnetic force with the one or more voltages.

51. The method according to claim 50, wherein the setting the one or more voltages comprises using, for each of one or more mutually non-overlapping winding groups each constituted by at least two of the windings and capable of generating mutually cancelling components of the resultant magnetic force, only zero voltages and current-decreasing voltages in response to a need (310) to decrease operating points of operating quantities of the winding group under consideration.

52. The method according to claim 50, wherein the setting the one or more voltages comprises using, for each of one or more mutually non-overlapping winding groups each constituted by at least two of the windings and capable of generating mutually cancelling components of the resultant magnetic force, only zero voltages and current-increasing voltages in response to a need (312) to increase operating points of operating quantities of the winding group under consideration.

53. A non-volatile computer readable medium encoded with a computer program for controlling a magnetic levitation system, the computer program comprising:
computer executable instructions for controlling a programmable processing system to control one or more voltages directed to one or more windings of the magnetic levitation system on the basis of a deviation of a position of an object from a reference position of the object so as to control a resultant magnetic force directed to the object,
wherein the computer program comprises computer executable instructions for controlling the programmable processing system to:
select, for each of temporally successive control periods, a control direction so that changing the resultant magnetic force in the selected control direction improves ability of a total force acting on the object to decrease the deviation of the position, and
set, for each of the temporally successive control periods, the one or more voltages in accordance with the selected control direction so as to decrease the deviation of the position by changing the resultant magnetic force with the one or more voltages.

54. The non-volatile computer readable medium according to claim 53, wherein the computer program comprises computer executable instructions for controlling the programmable processing system to use, for each of one or more mutually non-overlapping winding groups each constituted by at least two of the windings and capable of generating mutually cancelling components of the resultant magnetic force, only zero voltages and current-decreasing voltages in response to a need to decrease operating points of operating quantities of the winding group under consideration.

55. The non-volatile computer readable medium according to claim 53, wherein the computer program comprises computer executable instructions for controlling the programmable processing system to use, for each of one or more mutually non-overlapping winding groups each constituted by at least two of the windings and capable of generating mutually cancelling components of the resultant magnetic force, only zero voltages and current-increasing voltages in response to a need to increase operating points of operating quantities of the winding group under consideration.

56. The control device according to claim 30, wherein the controller is configured to use, for each of one or more mutually non-overlapping winding groups each constituted by at least two of the windings and capable of generating mutually cancelling components of the resultant magnetic force, only zero voltages and current-increasing voltages in response to a need to increase operating points of operating quantities of the winding group under consideration.

57. The control device according to claim 33, wherein the controller is configured to determine a temporal length of each of the temporally successive control periods on the basis of (i) the one or more control values indicating required changes of the one or more control quantities and (ii) a fact that the one or more voltages set for the control period under consideration at least partly determine a rate of change of each of the one or more control quantities.

58. The control device according to claim 33, wherein the controller is configured to keep, in order to reduce switching frequency, the one or more voltages unchanged with respect to corresponding one or more voltages used during a previous one of the temporally successive control periods in response to a situation in which a vector norm of the one or more control values is below a pre-determined limit.

59. A control device according to claim 35, wherein the controller is configured to keep, in order to reduce switching frequency, the one or more voltages unchanged with respect to corresponding one or more voltages used during a previous one of the temporally successive control periods in response to a situation in which a vector norm of the one or more control values is below a pre-determined limit.
